(19) United States
(12) Patent Application Publication
(10) Pub. No.: US 2014/0291474 A1
(43) Pub. Date: Oct. 2, 2014

(54) MEANS FOR LOCATING AND ACCESSING AN OBJECT FROM ONE SIDE OF A PARTITION

(71) Applicants: Nathan Paul Wilson, Dulwich (AU); Gary John McMahon, Dulwich (AU); James William Scales, Dulwich (AU)

(72) Inventors: Nathan Paul Wilson, Dulwich (AU); Gary John McMahon, Dulwich (AU); James William Scales, Dulwich (AU)

(73) Assignee: MAKE SAFE PTY LTD, Dulwich (AU)

(21) Appl. No.: 14/129,587

(22) PCT Filed: Jun. 28, 2012
(86) PCT No.: PCT/AU2012/000790

§ 371 Date: Apr. 18, 2014

(30) Foreign Application Priority Data
Jun. 28, 2011 (AU) 2011902539

(51) Int. Cl. F16M 13/02; E04B 1/72; A01M 25/00

(52) U.S. Cl. CPC F16M 13/02; A01M 25/002; E04B 1/72
USPC 248/544

(57) ABSTRACT

This invention relates to a means for locating and accessing an object on one side of a partition from the other side of the partition, for the purpose of easy and convenient access and inspection of the object.

### FIELD OF THE INVENTION

The present invention relates to a means for locating and accessing an object on one side of a partition from the other side of the partition,.

### PRIORITY

This patent application claims priority from:

Australian Provisional Patent Application 2011902539, titled “MEANS FOR LOCATING AND ACCESSING AN OBJECT FROM ONE SIDE OF A PARTITION”, and filed on 28 Jun. 2011.

The entire content of this application is hereby incorporated by reference.

### BACKGROUND OF THE INVENTION

In this specification, partition refers to any form of surface or barrier where there is convenient access on one side but restricted or no access on the other side. Partition will therefore include structures such as a floor or wall panels, floor boards, brick walls and the like. But the term will also include any structure or surface such as containers, vehicles or aircraft for example and is therefore not limited to building applications.

Difficulty arises when ready access is required to objects that may be located within a ceiling space, behind a wall, under a floor, or in any other confined space of a house or building.

Having regard to a specific example, it is common to locate pesticides such rodent baits within a ceiling space of a house or building. It is then difficult and time consuming to inspect the bait to determine whether or not they are being consumed and if they need replacing.

In addition to the example provided above, the invention has many applications that will be readily apparent from the description below. For example, in addition to rodent baits, the objects to be accessed may include gels, powders, liquids or bait applicators, or even smoke detectors and the like.

It is against this background that the problems and difficulties associated therewith that the present invention has been developed.

Certain objects and advantages of the present invention will become apparent from the following description, taken in connection with the accompanying drawings, wherein, by way of illustration and example, an embodiment of the present invention is disclosed.

### SUMMARY OF THE INVENTION

Accordingly, the invention provides a means for easy and convenient access for the above mentioned application together with other instances where objects, which are located on another side of a partition, may be accessed.

In one aspect, the invention may be said to reside in a means for locating and accessing an object on one side of a partition from the other side of the partition, the means comprising: an aperture in the partition,
a carrier body for locating in the aperture having means for carrying an object,
connecting means on the carrier body for releasably securing the carrier body with respect to the aperture, and
a tool that engages with the carrier body to hold the carrier body to allow it to be removed from or located into the aperture.

In one form, the means for locating and accessing an object of claim 1, further comprising a housing mountable within an opening in the partition, the housing comprising the aperture in which the carrier body is located.

In one form, the carrier body forms a closure for the aperture in the partition and the means for carrying the object may comprise a recess or an adaptation for carrying or connecting an object thereto.

In one form, the aperture and the carrier body are circular in cross section and the connecting means secures with respect with the aperture by rotating the carrier body in one direction and disconnects from the aperture by rotating the carrier body in the opposite direction.

In one form, the tool is manually operated so that it can be positioned to engage with the carrier body in a manner that the carrier body is held by the tool so that it can be engaged with or removed from the aperture.

In one form, the tool has a plurality of projections that engage with a corresponding plurality of recesses within the carrier body. Projections on the tool my be hook like members that allow the carrier body to be manually rotated and pulled downwardly so as to remove the carrier body from the aperture in the partition. In the reverse manner the tool can be used to locate the carrier body within the aperture and rotate it in a manner that allows the connecting means to engage with the respect aperture.

In a further aspect of the invention, there is provided a means for locating and accessing an object from one side a partition comprising:
a housing mountable within an opening in the partition,
an aperture within the housing,
securing means on the housing within the aperture,
carrier body for locating into the aperture within the housing having a means for carrying an object,
connecting means on the carrier body that engage with the securing means in the aperture to hold the carrier body within the housing and
a tool that engages with the carrier to hold the carrier body and allow it to be removed or located into the aperture of the housing.

In one form, the housing, the aperture within the housing and the carrier body have a circular cross section. However, the invention would equally work with the aperture in a carrier body having a rectilinear cross section with the housing also having a rectilinear cross section.

In one form, the connecting means on the carrier body is engaged and disengaged with the securing means in the aperture by rotation of the carrier body with respect to the housing.

In one form, the securing means in the aperture may include latching means which lockably secures the carrier body within the housing.

In one form, the carrier body may have an end which covers the aperture within the housing. The means for carrying an object may comprise a recess within the carrier body or means that engages with the carrier body to hold an object thereto.

In one form, the tool that is manually engaged with the carrier body to enable it the located and removed from the housing.

In one form, the tool has the plurality of projections which locate within respective apertures within the carrier body to enable the tool to both engage and disengage the carrier body with respect to the housing. Preferably, this occurs by rotation of the carrier body with respect to the housing. The projections on the tool may have hook portions which enable the carrier body to be pulled away from the housing to assist disengaging the carrier body from the aperture.

In one form, the projections on the tools may be used to engage with latches to disengage the latch to thereby allow removal of the carrier body from the housing.

In one form, the latches may comprise of plurality of sprung fingers which enable a portion of the connecting means on the carrier body to pass a finger where upon the finger drops behind the connecting means to thereby latch it in place. To disengage the latch, the projections on the tool press against the sprung fingers to move them out of the latch position to thereby allow the connecting means to pass as the carrier body is rotated.

In one form, in relation to both aspects of the invention, the tool has a handle means, which enables manipulation of the tool. Alternatively, the tool may be located on the end of a shaft to enable access to a carrier that is located in a ceiling.

In order to further understand the invention, preferred embodiments, will now be described. However, it will be realised that the scope of the invention is not be confined or restricted to the details of the embodiments described below. Variations and alterations that would be readily apparent to a person skilled in the art are deemed as being incorporated within the scope of the invention.

### BRIEF DESCRIPTION OF THE DRAWINGS

An illustrative embodiment of the present invention will be discussed with reference to the accompanying drawings wherein:

FIGS. 1 and 2 are exploded views of a first embodiment of the invention;

FIG. 3 is an assembled view of the first embodiment of the invention illustrated in FIGS. 1 and 2;

FIGS. 4 and 5 are perspective views of a housing of the first embodiment of this invention;

FIG. 6 is an upper perspective view of a carrier body according to the first embodiment;

FIG. 7 is an underside perspective view of the carrier body illustrated in FIG. 6;

FIG. 8 is an exploded view of a second embodiment of the invention;

FIGS. 9 and 10 are assembled views of the second embodiment of the invention; and

FIG. 11 is an upper perspective view of a third embodiment of the invention.

In the following description, like reference characters designate like or corresponding parts throughout the several views of the drawings.

### DESCRIPTION OF ILLUSTRATIVE EMBODIMENT

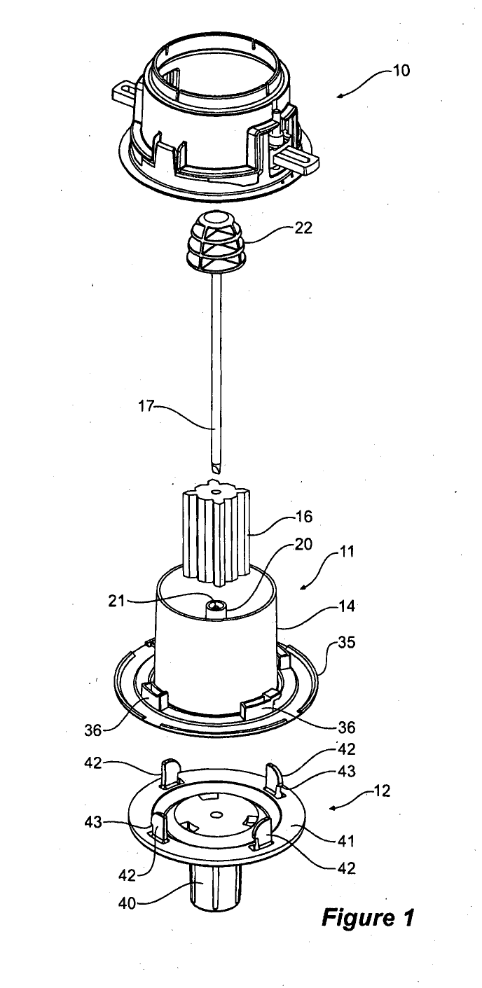

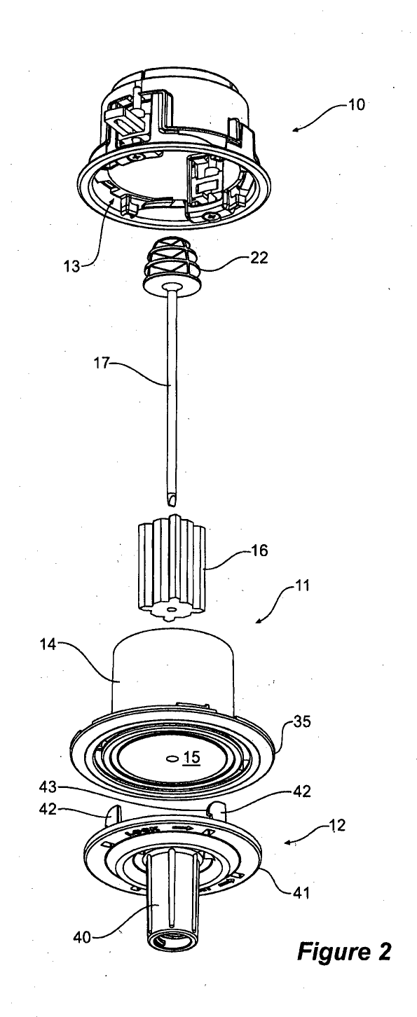

Referring to FIG. 1, where there is illustrated an exploded view of an assembly comprising a housing 10, a carrier body 11, and a tool 12. As best seen in FIG. 2, the housing 10 has an aperture 13 within which a cylindrical extension 14 of the carrier body 11 locates. The carrier body 11 has an end 15 which is substantially planar in shape and covers the aperture 13. The diameter of the end 15 is larger than the largest diameter portion of the housing 10.

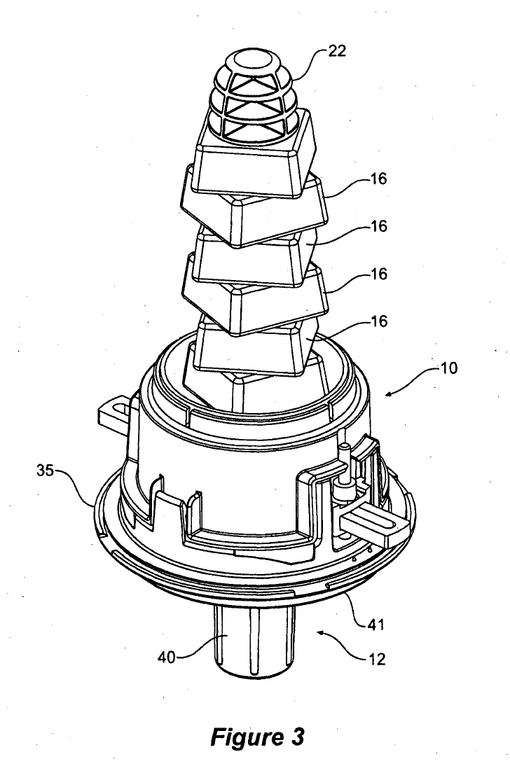

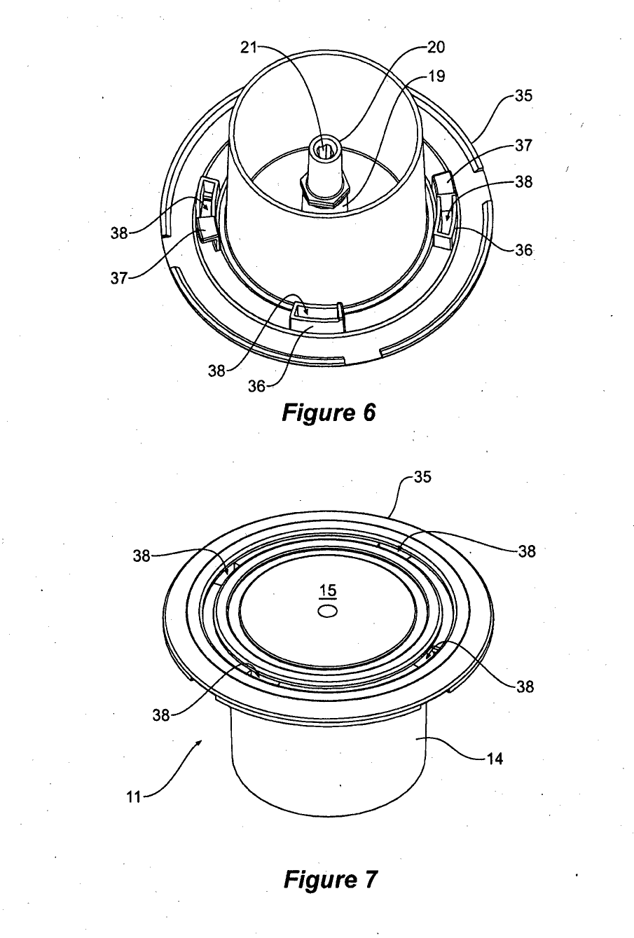

The cylindrical extension 14 has a tubular wall which is open at its upper end to form a means for carrying an object. In this embodiment, the object is a rodent bait 16 which is secured to the carrier body 11 by a skewer 17. The carrier body 11 has a spigot 19 (refer FIG. 6) having an aperture within which locates a spindle 20. The spindle 20 has an aperture 21 within which the lower end of the skewer 17 locates. The spindle 20 has an aperture 21 in each end and so can be reversed if the aperture 21 wears to the point where the skewer 17 becomes loose. As seen in FIGS. 1, 2 and 3, the skewer 17 locates through either a single block 16 of rodent bait or a plurality of rodent blocks 16 as shown in FIG. 3. The skewer 17 has a handle portion 22 to enable easy engagement and disengagement of the skewer 17.

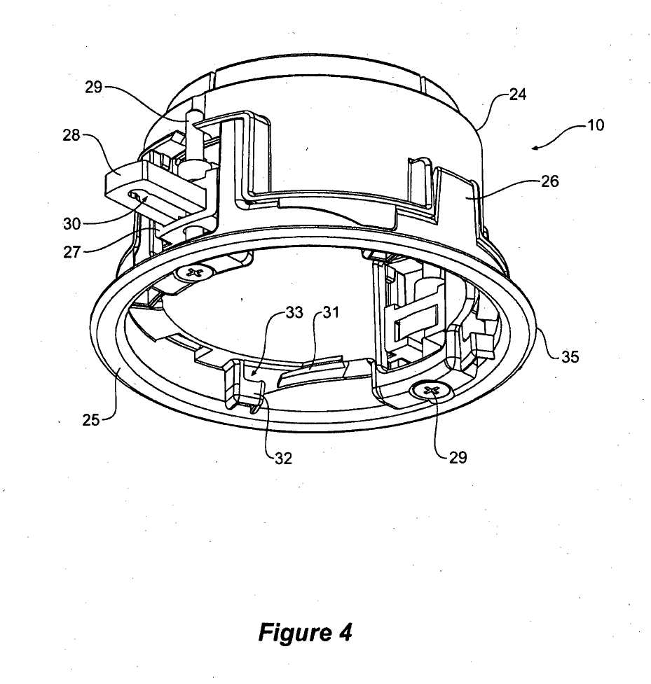

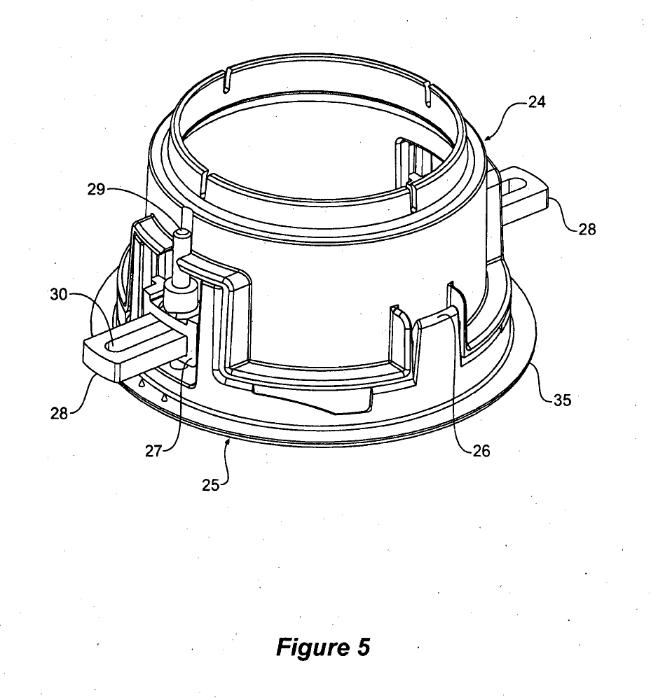

The housing 10, best seen in FIG. 4, comprises 2 separate mouldings. There is an upper portion 24 and a lower portion 25. The lower portion has a pair of spring loaded clips 26 that latch when the lower portion 25 is inserted within the upper portion 24. The use of an upper and lower portions 24 and 25 enable the various components of the housing 10 to be manufactured using plastic moulding techniques, as explained below.

For example, the means of retaining the housing 10 with respect to an aperture in a partition comprises a pair of sliding nuts 27 and wings 28 between the upper and lower portions 24 and 25. Each nut 27 is engaged with a thread fastener 29 and the shaft of the threaded fastener locates through the slot 30 of each wing 28. The wing 28 can be pushed inwardly so that it does not project substantially from either the nut 27 or the peripheral edge of the housing 10. This enables the housing 10 to be located within an aperture having a diameter of the upper portion of the housing 10 so that the flange 35 of the housing 10 abuts against the lower surface of the partition within which it is installed. For example, this may be a wall, ceiling or floor panel of a thickness commonly used in the construction of houses or buildings. Each wing 28 is then pushed outwardly and the threaded fasteners 29 are rotated so as to draw the nut 27 and respective wing 28 downwardly so that the wings 28 bear against the upper surface of the partition. The partition is then gripped between the wings 28 and the flange 35. By this means, sufficient retaining force can applied to securely locate the housing 10 with respect to a partition.

The housing 10 has a securing means located within the aperture 13 which comprises a number of sprung fingers 31 that are moulded to the upper portion 24 and a corresponding number of lugs 32 that are moulded to the lower portion 25. The lugs 32 have a recess 33 the operation of which will be explained below.

The carrier body 11 has a flange 35 upon which are located connecting means which in this embodiment are spigots 36 (see FIG. 1) that are radially spaced around the flange 35. Each of the spigots 36 has a single projection 37 extending from the upper edge of spigot 36.

The carrier body 11 is secured to the housing by inserting it within the aperture 13 and rotating it with respect the housing 10. Each of the spigots 36 align below a respective sprung finger 31 and by pushing the carrier body 11 into the aperture 13 the spigots 36 depress the sprung fingers 31 sufficiently to enable the projections 37 to align with the recesses 33. This is turn enables the carrier body 11 to rotate with respect to the housing 10 to allow the projections 37 to engage the recess 33. The spigots 36 will abut against the lugs 32 to limit the rotation of the carrier body 11 with respect to the housing 10. In this position, the sprung fingers 31 are released and each locate within a respective aperture 38 (see FIG. 6) formed through each of the spigots 36. In this position, the sprung fingers 31 prevent rotation of the carrier body 11 in the release direction.

As mentioned above, the flange 35 of the carrier body 11 has a diameter that is larger than the flange 30 on the housing 10. Accordingly, the only component visible from one side of the partition is the end 15 of the carrier body 11.

The tool 12 comprises a handle portion 40 a circular plate 41 and four spigots 42. The spigots 42 are positioned and orientated to engage the apertures 38 that are in the centre of the spigots 36. With the carrier body 11 located within the housing 10, the spigots 42 are sufficiently long enough so that when the handle 12 is engaged with the carrier body 11, the spigots 42 press the spring fingers 31 sufficiently to disengage them from the apertures 38. Once the sprung fingers 31 are removed from their locking position, the handle 40 can be rotated, which also rotates the carrier body 11 to a position whereby it can be withdrawn from the housing 10. The spigots 42 may be provided with a hook portion 43 that engages with a ledge 44 within the aperture 38 to enable the tool 12 to provide an extracting force to the carrier body 11 to thereby pull it from the housing.

As can been seen from the above description the carrier body 11 can be used to locate rodent baits within the recess formed in the cylindrical extension 14 then to insert the carrier body 11 into the housing 10 which may for example be mounted within a ceiling panel. This enables the rodent bait 16 to easily locate into the ceiling space and for that rodent bait 16 to be inspected by simply removing the carrier body 11 from the housing 10. The tool 12 is used to engage the carrier body 11 to disengage the securing and connecting means respectively to disengage the carrier body 11 from the housing to inspect the rodent bait 16 and replace if necessary.

The handle portion 40 of tool 12 is tubular with an open end into which a pole such as a painter's pole can be located. The internal surface of the handle 40 may be threaded to enable connection of a standard painter's pole. This enables the tool 12 to be used in an elevated position, such as a ceiling, without need to use a ladder.

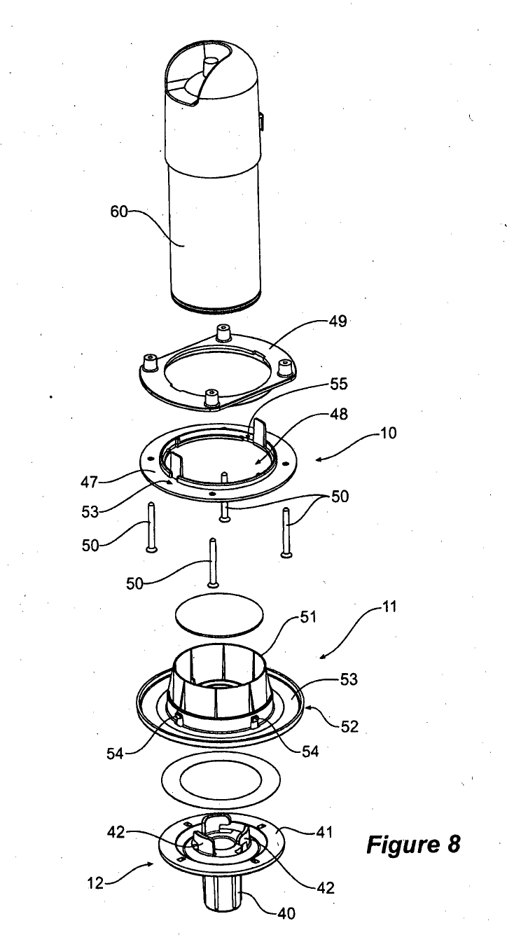

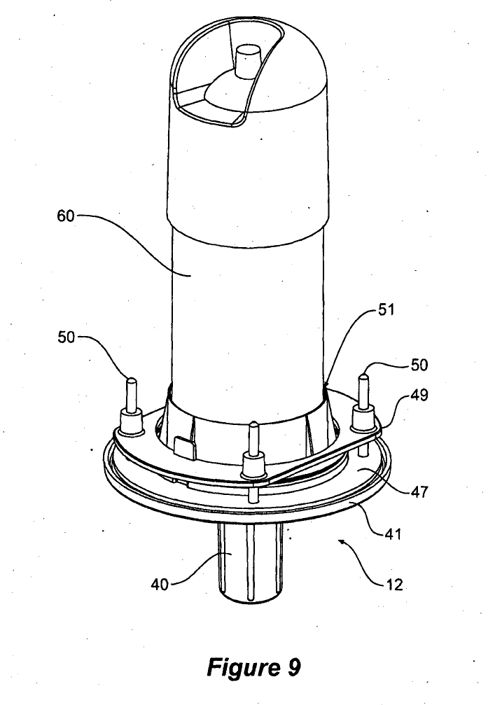

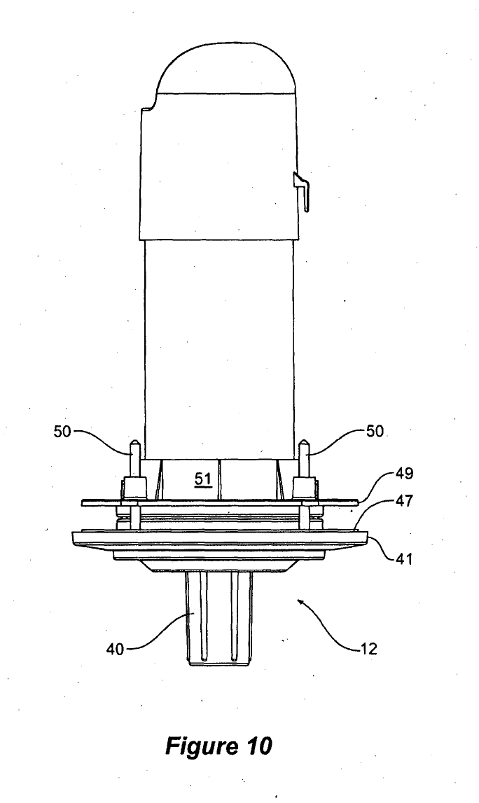

The first embodiment shows use with the respect to rodent baits. However, the carrier body may hold or carry a number of different items. For example, as seen in FIGS. 8 through 10, the carrier body may hold a pressure pack spray can having an automatic actuator that periodically discharges insecticide form the spray can into a ceiling space. Alternatively, the carrier may support an electronic deterrent device used to repel animals from within ceiling spaces or cavities in a building or house. The electronic deterrent may include flashing lights or an ultra-sonic noise generator to deter animals such as possums.

In the embodiment shown in FIGS. 8 through 10, there is provided a housing 10, a carrier body 11 and a tool 12. In this embodiment, the housing 10 comprises a first flange 47 that locates on one side of a partition such as a ceiling within which an aperture has been cut. The aperture 48 in the flange 47 aligns with the aperture formed in the partition. A flange retaining member 49 is located on the opposite side of the partition with respect to the flange 47 and threaded fasteners 50 locate through respective apertures within the flange 47 and threadably engage with the retaining member 49 to clamp the partition between the flange 47 and retaining member 49.

The carrier body 11 has a tubular cylindrical portion 51 that locates within the aperture 48 and a circular plate 52 forming a flange 53 around the cylindrical tubular portion 51.

The carrier body 11 has a number of radially spaced lugs 54 that engage respective recesses 55 in the flange 47. The carrier body 11 is secured to the housing 10 by aligning the lugs 54 with the recesses 55 and rotating the carrier body 11 as so at to lock the lugs 54 within the bayonet style recesses 55.

The tool 12 has a handle 40, a plate 41 and a number of upstanding spigots 42. The circular plate 52 on the carrier body 11 has a corresponding number of apertures within which the spigots 42 locate. The spigots 42 have a hook portion 43 that engages with the circular plate 52 at the edge of the apertures to thereby enable the tool 12 to apply a retracting force to the carrier body 11.

As seen in FIGS. 8 through 10 the cylindrical tubular portion 51 has a recess which enables the base of an aerosol can 60 to be retained therein. There is a friction fit between the aerosol can 60 and the recess of the cylindrical tubular portion 51 to firmly hold the aerosol can 60.

As described above in respect to the first embodiment, the second environment illustrated in FIGS. 8 through 10 provides an easy means of accessing the aerosol can 60 for replacement. The handle 40 may have an aperture within which a staff or painter's pole may be located to enable a carrier body Il in an elevated position to be easily accessed. As an alternative, the carrier body 11 shown in FIGS. 8 through 10 may, instead of carrying a spray can, have a spigot 20 and skewer 17 that locates in an aperture 21 within the spigot 20. This enables simplified insertion and removal without the use of a latching system.

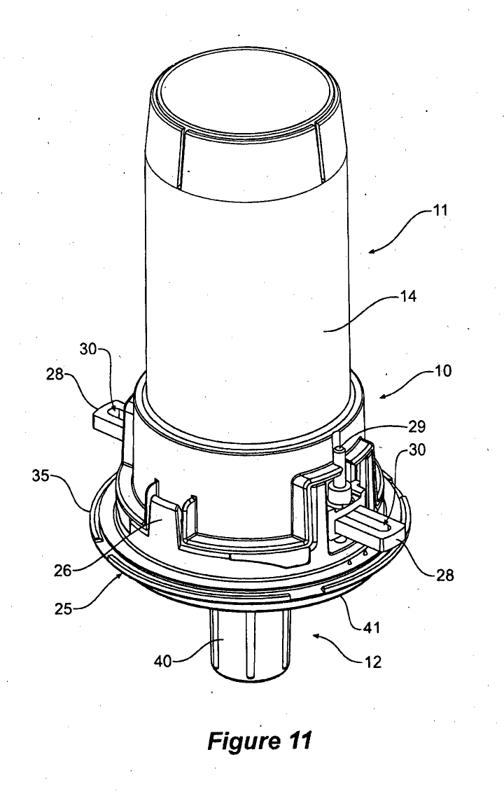

Referring now to FIG. 11, where there is illustrated a further embodiment, where the housing 10 is mounted in a ceiling and the cylindrical extension 14 of the carrier body 11 acts as a housing for the workings of a smoke detector. In this way, the smoke detector is easily accessed from the ground, and it is mounted flush with the ceiling, not projecting downwardly therefrom in a manner which some consider unsightly.

In a non-illustrated alternative to the embodiment illustrated in FIG. 11, the carrier body 11 is adapted to provide means for securement of a conventional smoke detector thereto.

As will be seen from the above description, the invention provides an easy and convenient means of accessing an object that is to be located on a less accessible side of a partition.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that various modifications can be made without departing from the principles of the invention. Therefore, the invention should be understood to include all such modifications in its scope.

1. A means for locating and accessing an object on one side of a partition from the other side of the partition, the means comprising:
an aperture in the partition;
a carrier body for locating in the aperture, the carrier body comprising means for carrying the object;
connecting means for releasably securing the carrier body with respect to the aperture; and
a tool that engages with the carrier body to hold the carrier body for removal from or locating in the aperture.

2. The means for locating and accessing an object of claim 1, further comprising a housing mountable within an opening in the partition, the housing comprising the aperture in which the carrier body is located.

3. The means for locating and accessing an object as in claim 1, wherein the carrier body forms a closure for the aperture.

4. The means for locating and accessing an object as in claim 1, wherein the means for carrying the object comprises a recess or an adaptation for carrying the object or connecting the object thereto.

5. The means for locating and accessing an object as in claim 1, wherein the aperture and the carrier body are circular in cross section and the connecting means secures the carrier body with respect to the aperture by rotating the carrier body in a first direction, and disconnects the carrier body from the aperture by rotating the carrier body in an opposing direction.

6. The means for locating and accessing an object as in claim 1, wherein the tool is manually operated so that it can be positioned to engage with the carrier body in such a manner that the carrier body is held by the tool so that the carrier body can be engaged with or removed from the aperture.

7. The means for locating and accessing an object as in claim 1, wherein the tool has a handle means, which enables manipulation of the tool.

8. The means for locating and accessing an object as in claim 1, wherein the tool comprises a plurality of projections that engage with a corresponding plurality of recesses within the carrier body.

9. The means for locating and accessing an object of claim 8, wherein the projections comprise hook like members that allow the carrier body to be manually rotated and pulled downwardly so as to remove the carrier body from the aperture.

10. The means for locating and accessing an object as in claim 8, wherein the connecting means comprises latching means biased to effect capture of the carrier body, and wherein in use the tool projections selectively actuate said latching means against said bias to effect release of the carrier body from the aperture.

11. The means for locating and accessing an object as in claim 1, wherein the object is a bait for a pest.

12. The means for locating and accessing an object as in claim 11, wherein the bait is lethal for the pest.

13. The means for locating and accessing an object as in claim 1, wherein the object is a pest repellent.

14. The means for locating and accessing an object as in claim 1, wherein the object is an aerosol dispenser.

15. The means for locating and accessing an object as in claim 1, wherein the object is a smoke detector.

16. The means for locating and accessing an object as in claim 1, wherein the partition is one of a floor, wall or ceiling of a building.

17. The means for locating and accessing an object as in claim 16, wherein the tool may be located on the end of a shaft to enable access to the carrier body and assist such access where the carrier body is located in the ceiling or the floor in particular.
